(19) United States
(12) Patent Application Publication
(10) Pub. No.: US 2022/0097218 A1
(43) Pub. Date: Mar. 31, 2022

(54) Cam Lock Chain Tool Apparatus

(71) Applicant: Budd Hetrick, Bend, OR (US)

(72) Inventor: Budd Hetrick, Bend, OR (US)

(21) Appl. No.: 17/032,038

(22) Filed: Sep. 25, 2020

(51) Int. Cl. B25B 27/22

(52) U.S. Cl. CPC B25B 27/22

(57) ABSTRACT

A cam lock chain tool apparatus for safely and effectively installing and removing tire chains includes a receiver body having a receiver front side, a receiver back side, a receiver left side, a receiver right side, a receiver top side, and a receiver bottom side. The receiver bottom side has a receiver aperture dimensioned to receive a standard socket wrench. An extender is coupled to the receiver body. The extender is coupled to the receiver top side. A tab is coupled to the extender. The tab is dimensioned to engage a cam lock for a tire chain.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to chain tool devices and more particularly pertains to a new chain tool device for safely and effectively installing and removing tire chains.

### (2) Description of Related Art Including Information Disclosed Under 37 CFR 1.97 and 1.98

The prior art relates to chain tool devices. Existing devices include custom wrenches and full individual tools to manipulate cam locks for tire chains. Other devices include socket wrench attachments but do not properly engage cam locks. Such devices lack a compact sock wrench attachment which perfectly engages the cam lock of a tire chain for quick, effective, and safe work.

### BRIEF SUMMARY OF THE INVENTION

An embodiment of the disclosure meets the needs presented above by generally comprising a receiver body having a receiver front side, a receiver back side, a receiver left side, a receiver right side, a receiver top side, and a receiver bottom side. The receiver bottom side has a receiver aperture dimensioned and configured to receive a standard socket wrench. An extender is coupled to the receiver body. The extender is coupled to the receiver top side. A tab is coupled to the extender. The tab is dimensioned and configured to engage a cam lock for a tire chain.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a cam lock chain tool apparatus according to an embodiment of the disclosure.

FIG. 2 is a front elevation view of an embodiment of the disclosure.

FIG. 3 is a bottom plan view of an embodiment of the disclosure.

FIG. 4 is a top plan view of an embodiment of the disclosure.

FIG. 5 is a side elevation view of an embodiment of the disclosure.

FIG. 6 is an in-use view of an embodiment of the disclosure.

### DETAILED DESCRIPTION OF THE INVENTION

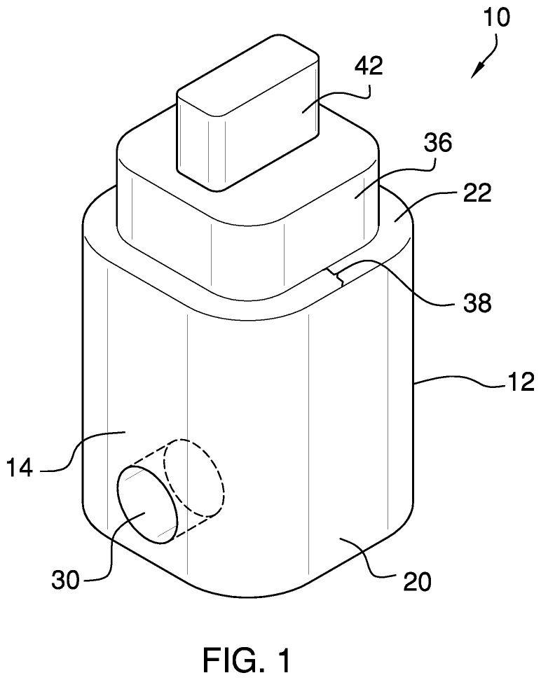

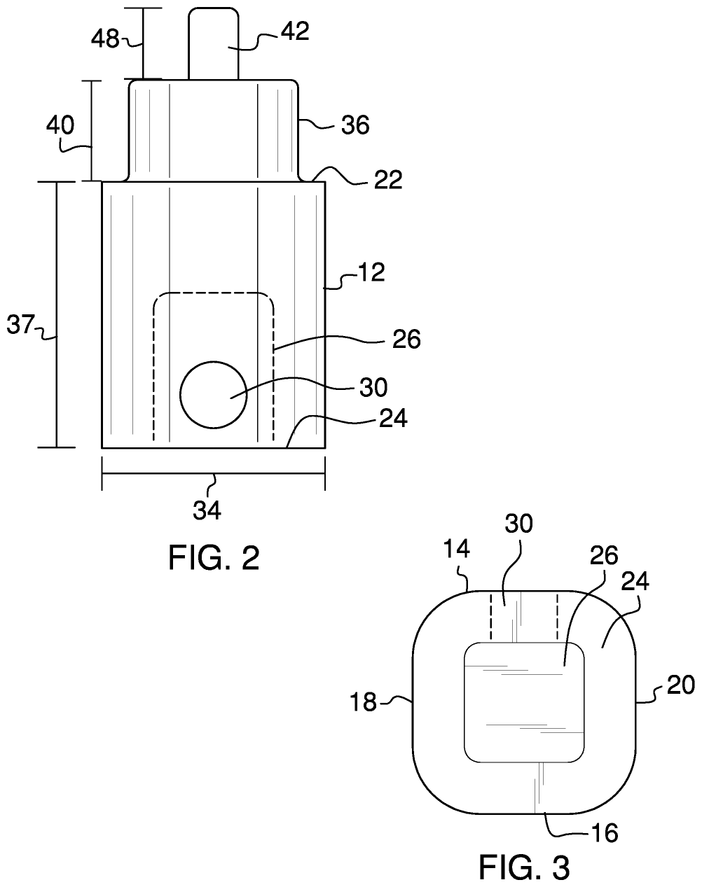

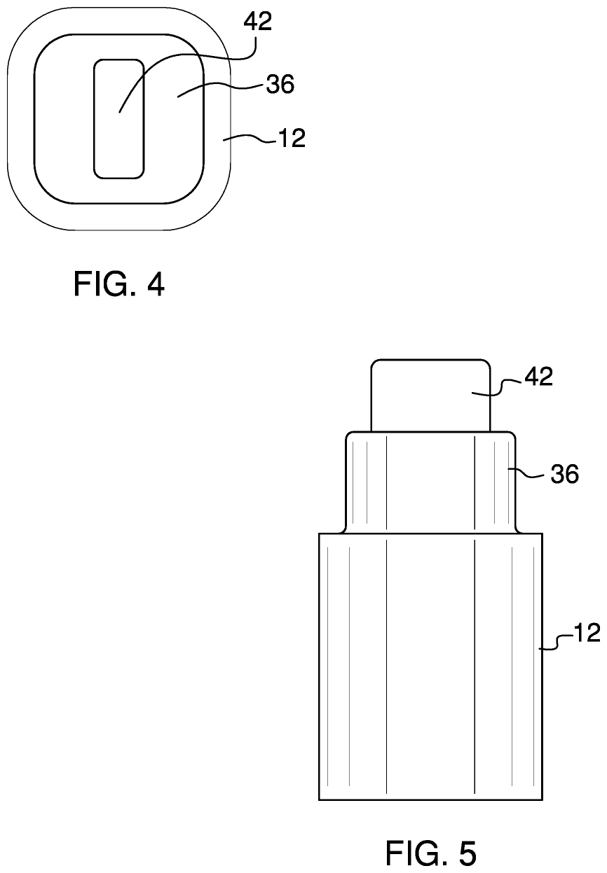

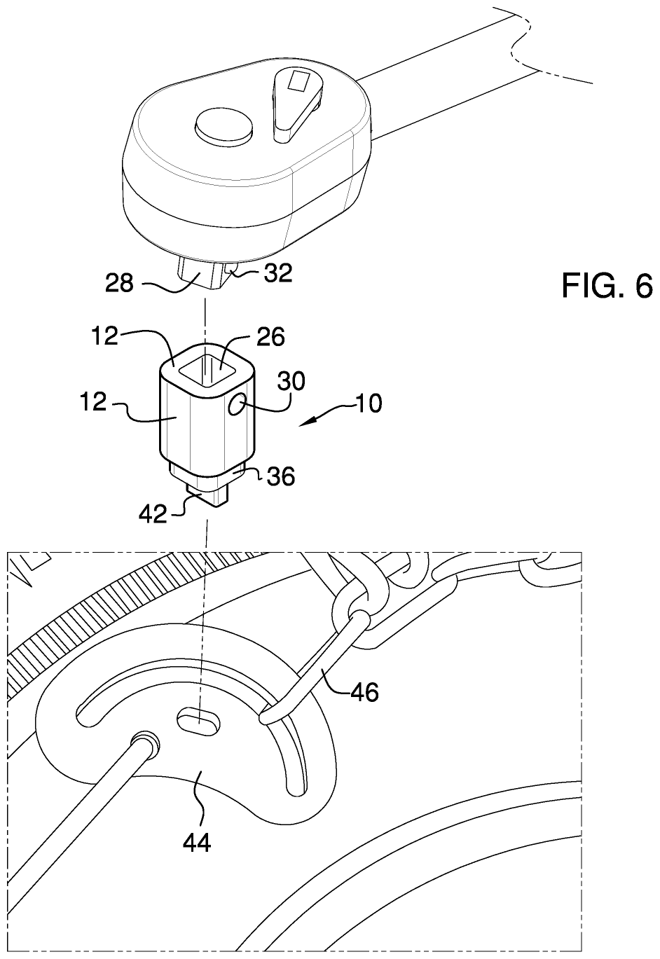

With reference now to the drawings, and in particular to FIGS. 1 through 6 thereof, a new chain tool device embodying the principles and concepts of an embodiment of the disclosure and generally designated by the reference numeral 10 will be described.

As best illustrated in FIGS. 1 through 6, the cam lock chain tool apparatus 10 generally comprises a receiver body 12 having a receiver front side 14, a receiver back side 16, a receiver left side 18, a receiver right side 20, a receiver top side 22, and a receiver bottom side 24. The receiver bottom side 24 has a receiver aperture 26 dimensioned and configured to receive a standard socket wrench 28. The receiver front side 14 may have a bearing aperture 30 extending through to the receiver aperture 26. The bearing aperture 30 is configured to receive a bearing 32 of the standard socket wrench to secure the receiver body 12.

The receiver body 12 and the receiver aperture 26 may be dimensioned to receive a standard ⅜″ or ½″ socket wrench. The receiver bottom side 24 may be substantially squared and may have a receiver width 34 of 1″. A receiver height 37 of the receiver body 12 may be greater than the receiver width 34.

An extender 36 is coupled to the receiver body 12. The extender 36 is coupled to the receiver top side 22. The profile of the extender 36 may conform to the profile of the receiver body 12 reduced in size. The receiver top side 22 thus has a uniform perimeter 38 surrounding the extender 36. An extender height 40 of the extender may be less than 50% of the receiver height 37.

A tab 42 is coupled to the extender 36. The tab 42 may be rectangular prismatic and is dimensioned and configured to engage a cam lock 44 for a tire chain 46. A tab height 48 of the tab is less than the extender height 40.

The receiver body 12, the extender 36, and the tab 42 may have rounded vertical edges for user comfort while securing the apparatus 10 during use. The extender 36 provides additional surface area for the user to secure and also creates separation between the tab 42 and the 28 socket wrench 28 to prevent interference with the cam lock 44 or the tire chain 46.

In use, the receiver aperture 26 is engaged with the standard socket wrench 28 so the bearing aperture 30 receives the bearing 32. The tab 42 is then engaged with the cam lock 44 to allow the user to manipulate the standard socket wrench 28 to install or remove the tire chain 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A cam lock chain tool apparatus comprising:
a receiver body having a receiver front side, a receiver back side, a receiver left side, a receiver right side, a receiver top side, and a receiver bottom side, the receiver bottom side having a receiver aperture dimensioned and configured to receive a standard socket wrench;
an extender coupled to the receiver body, the extender being coupled to the receiver top side; and
a tab coupled to the extender, the tab being dimensioned and configured to engage a cam lock for a tire chain, the tab being rectangular prismatic and having a pair of elongated planar and parallel longitudinal sides and pair of planar and parallel ends perpendicular to the longitudinal sides, the longitudinal sides extending laterally across the extender, the tab having rounded corners between the longitudinal sides and the ends of the tab.

2. The cam lock chain tool apparatus of claim 1 further comprising the receiver front side having a bearing aperture extending through to the receiver aperture, the bearing aperture being configured to receive a bearing of the standard socket wrench to secure the receiver body.

3. The cam lock chain tool apparatus of claim 1 further comprising the receiver body, the extender, and the tab having rounded vertical edges.

4. (canceled)

5. The cam lock chain tool apparatus of claim 1 further comprising a tab height of the tab being less than an extender height of the extender, the extender height being less than a receiver height of the receiver.

6. The cam lock chain tool apparatus of claim 1 further comprising the profile of the extender conforming to the profile of the receiver body reduced in size, the receiver top side thus having a uniform perimeter surrounding the extender.

7. A cam lock chain tool apparatus comprising:
a receiver body having a receiver front side, a receiver back side, a receiver left side, a receiver right side, a receiver top side, and a receiver bottom side, the receiver bottom side having a receiver aperture dimensioned and configured to receive a standard socket wrench, the receiver front side having a bearing aperture extending through to the receiver aperture, the bearing aperture being configured to receive a bearing of the standard socket wrench to secure the receiver body;
an extender coupled to the receiver body, the extender being coupled to the receiver top side, the profile of the extender conforming to the profile of the receiver body reduced in size, the receiver top side thus having a uniform perimeter surrounding the extender; and
a tab coupled to the extender, the tab being rectangular prismatic, the receiver body, the extender, and the tab having rounded vertical edges, the tab being dimensioned and configured to engage a cam lock for a tire chain, comprising a tab height of the tab being less than an extender height of the extender, the extender height being less than a receiver height of the receiver, the tab having a pair of elongated planar and parallel longitudinal sides and pair of planar and parallel ends perpendicular to the longitudinal sides, the longitudinal sides extending laterally across the extender, the tab having rounded corners between the longitudinal sides and the ends of the tab.
